(19) United States
(12) Patent Application Publication
(10) Pub. No.: US 2002/0097855 A1
(43) Pub. Date: Jul. 25, 2002

(54) Method for automatic phone service selection

(76) Inventors: Alexander J. Neudeck, Llama Ln Windsor, CO (US); Steven L. Webb, Loveland, CO (US)

Correspondence Address: HEWLETT-PACKARD COMPANY, Intellectual Property Administration, P.O. Box 272400, Fort Collins, CO, 80527-2400, US

(21) Appl. No.: 09/768,147

(22) Filed: Jan. 23, 2001

(51) Int. Cl. H04M 3/42

(52) U.S. Cl. 379/201.01

(57) ABSTRACT

A device that chooses a phone service for a call, based in part on the different calling plans, the time of the call, the number dialed, and the typical length of a call to the number dialed.

### FIELD OF THE INVENTION

The present invention relates generally to selecting a long distance phone service and more specifically to automatically picking a phone services for the current call.

### BACKGROUND OF THE INVENTION

Picking a phone service for a call is a complicated ordeal. There are many different phone services and each service has different rates that apply during different times, for different durations, and for different distances or different countries. Plus these rates don't stay the same. New calling plans seem to be announced every time you turn around. Remembering the access codes for the different phone service is also difficult. Is it 10-10 then your number or is it 10-220 then your number?

There is a need for a device that can select a phone service based on the number you are calling, the time you are calling, and how long you typically talk when you call this number.

### SUMMARY OF THE INVENTION

A device that chooses a phone service for a call, based in part on the different calling plans, the time of the call, the number dialed, and the typical length of a call to the number dialed and a subscription service to update the different calling plans.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is flow chart of the method of choosing a phone service according to the current invention.

FIG. 2 is block diagram of a device that selects phone services according to the present invention.

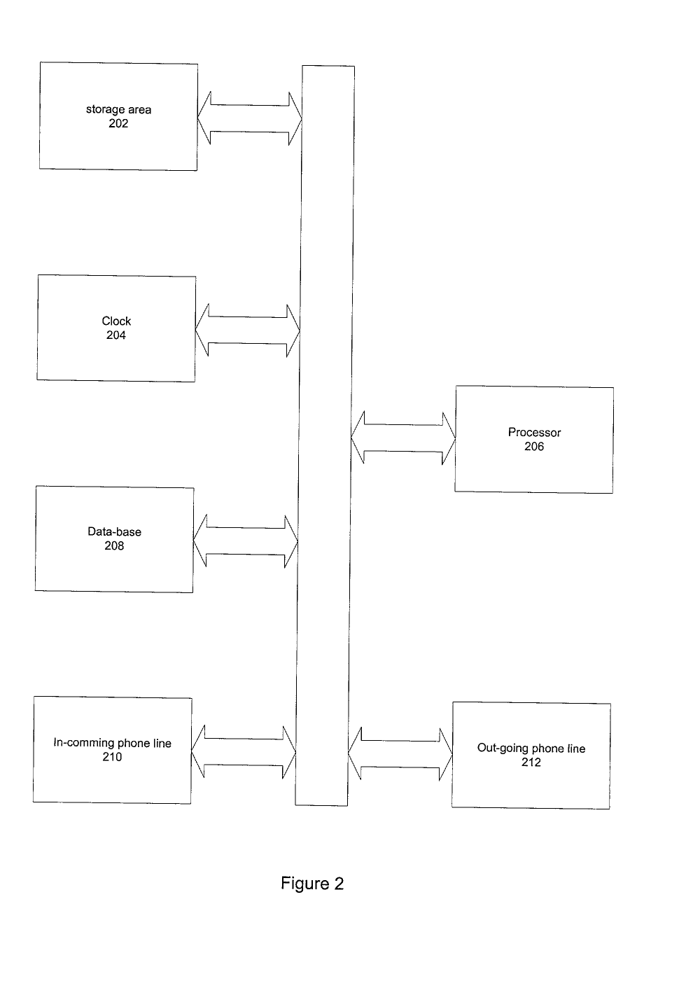

### DETAILED DESCRIPTION OF THE PREFERRED EMBODIMENT

A device that chooses a phone service for a call, based in part on the different calling plans, the time of the call, the number dialed, and the typical length of a call to the number dialed can reduce the complexity of using different long distance services.

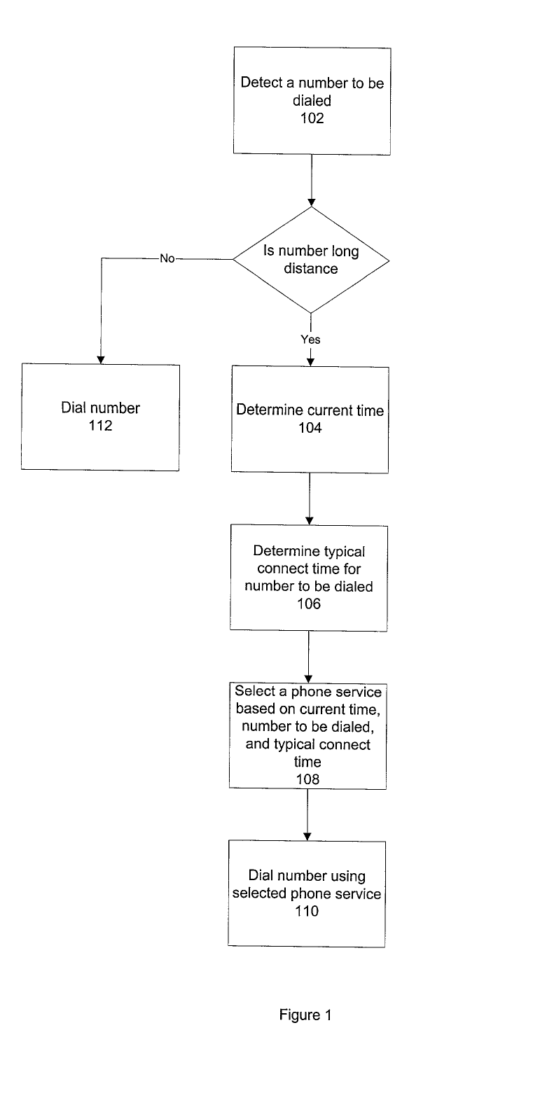

In one embodiment the device would be connected between the user's phone and the out-going phone line, like an answering machine. A method the device may use is shown in FIG. 1. When a user dials a number to be called, the device determines if the number is a long distance number or a local number. One way a long distance number can be determined is by the leading 1 in the number to be dialed. When it is a local number the device just dials or passes through the number (112). When the number to be dialed is a long distance number, the device determines the current time (104), the typical length of connect time for this number (106), and the destination of the number. The device then selects a long distance phone service based on these factors (108). The device then dials the access code for the long distance service and dials the number (110). When the user is done with the call, the device determines the length of the call and the time of day and adds this information to the storage area.

The device can determine the typical length of connect time for a number to be dialed in a number of different ways. One way is to use an average of the length of connect times for calls to this number over the last x number of time this number has been used. Another way is to use the mean instead of an average. Another way is to use a weighted average, where the most recent calls are given a higher weight than calls made in more distant times. The time of day can also be used in predicting the length of use for the number to be dialed. For example, a user may sometimes calls a number in the morning and talk for a short time, and sometimes calls the same number at night, and talk for a long time. When the number is dialed at night, the device would only use the night connect times to predict the connect time. The device may also discard connect times that are smaller than a preset minimum. For example, any connect time less than 30 second might be ignored. The device may also discard connect times from a number that has not been dialed recently. When a number to be dialed has never been dialed before, the device could use the average of all other calls, or the device could use a default number.

Once a typical connect time has been determined, the device will search through a database of phone service providers and select one based on the typical connect time, the current time of day, and the destination of the call. The database of phone services can be up-dated to keep the database accurate.

The database can be updated in a number of different ways. One way is for the user to input the information for each phone service provider, including the rates for each time period, length of call, destination location, and access code. The database can also be updated automatically using a number of different methods. One method is for the device to automatically connect to a database that is kept current and download this current database. For example, a service provider could update a web site, and the device could periodically connect to the web page and download the current database. Another method is to have a service that calls the device on a periodic basis and download a database. Or the service could call the device only when the database has changed. Another way is to provide all the different phone companies with access to the device and allow each phone company to update only its information in the device.

A personal computer connected to the World Wide Web through a phone line or a high-speed connection has all the required hardware for this device. Therefore another embodiment for this device is software running on a personal computer.

The foregoing description of the present invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for choosing a phone service, comprising:
determining a number being dialed;
determining a typical connect time for the number to be dialed;
determining a current time;
examining the available phone services and choosing a phone service based on the number being dialed, the typical connection time, and the current time.

2. The method of claim 1 further comprising the steps:
determining if the number being dialed is a local call;
passing through the number being dialed when the number being dialed is a local call.

3. The method of claim 1 further comprising the step:
storing the number dialed and the length of connect time when the call is finished.

4. The method of claim 1 where the available phone services that are examined, are kept in a database.

5. The method of claim 4 where the database is updated automatically.

6. The method of claim 5 where the database is updated using the World Wide Web.

7. The method of claim 5 where the database is updated by a service that downloads a current database on a periodic basis.

8. The method of claim 5 where the database is updated by a service that downloads a current database whenever the database changes.

9. The method of claim 1, further comprising the step of;
dialing the number dialed using the phone service selected, including any prefixes required by the phone service selected.

10. The method of claim 1 where the typical connect time is determined using past connect times for the number being dialed.

11. The method of claim 10 where the current time of day is a factor used in determining the typical connect time for the number being dialed.

12. A device that chooses a phone service, comprising:
a memory area;
a clock;
a database of phone services;
a processor connected to the memory area, the clock and the database of phone services;
the processor configured to detect a phone number to be called
the processor configured to store called phone numbers into the memory area, and configured to store the duration of the called phone numbers into the memory area;
the processor configured to select a phone service based on the phone number to be called, the current time, and the typical length of calls to the number to be called.

13. The device of claim 12 where the processor is also configured to dial the number to be called using the selected phone service.

14. The device of claim 12 where the database of phone services is updated automatically.

15. The device of claim 14 where the database is updated using the World Wide Web.

16. The device of claim 14 where the database in the device is updated by a service that downloads a current database to the device on a periodic basis.

17. The device of claim 14 where the database in the device is updated by a service that downloads a current database to the device whenever the database changes.
